(19) United States
(12) Patent Application Publication
(10) Pub. No.: US 2006/0200611 A1
(43) Pub. Date: Sep. 7, 2006

(54) Computer storage device interface cable

(75) Inventor: Yi-Long Huang, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/344,270

(22) Filed: Jan. 30, 2006

(30) Foreign Application Priority Data
Mar. 3, 2005 (CN) 200510033488.9

(51) Int. Cl. G06F 13/14

(52) U.S. Cl. 710/305

(57) ABSTRACT

A storage interface cable for advanced technology attachment (ATA) applications is provided. In a preferred embodiment, the storage interface cable comprises: a bus line conveying signals; a host connector at a middle part of the bus line for being attached to a host; a master connector at an end of the bus line for being attached to a master device; and a slave connector at another end of the bus line for being attached to a slave device. Because the host connector is at the middle part of the bus line, a length of the bus line between the host connector and the slave connector is not dependent on a length of the bus line between the host connector and the master connector. Therefore, the storage interface cable provides a configuration for a host and devices avoiding quality debasement of signals or data corruption due to excessive length of the bus line.

### BACKGROUND

1. Field of the Invention

The present invention relates to an interface cable, and particularly to a parallel advanced technology attachment (ATA) storage interface cable for computer storage devices.

2. General Background

Parallel ATA storage interfaces have become very common in personal computers, they provide a connection between a host and storage systems. Storage systems include disk drives, compact disk—read only memory drives, or other storage devices. The parallel ATA storage interface has been subject to a strong effort of standardization in order to increase speed, to improve interchangeability, and to bring additional functions. Recent developments regarding parallel ATA storage interfaces have been formulated in the American National Standards Institutes ATA-3/ATA-4 specifications X3.298-1997 and X3T13/D96153, which define the physical parameters of connectors and cables for interconnection between the host and the devices, as well as the electrical/logical characteristics of the interconnecting signals, and the commands and protocols involved in the operation of the storage device.

FIG. 3 illustrates a typical parallel ATA storage interface cable 1 of a host connector 11 with a first device connector 12 and a second connector 13 which are connected in a daisy chain configuration. A bus line 14 connects the host computer 11, the first device connector 12, and the second connector 13. The bus line 14 includes 40 conductors or 80 conductors. FIG. 4 illustrates the attachment of a first device 5 and a second device 7. The host connector 11 is attached to a host computer 3 or simply a motherboard. The first device connector 12 is attached to the first device 5 and the second connector 13 is attached to the second device 7. The first device is configured in a master mode. The second device operates as a slave. The attachment is achieved by means of the typical parallel ATA storage interface cable 1.

However, the parallel ATA interface cable 1 has 40 or 80 conductors all abutting one against another, so there is cross talk between the conductors. The greater a length of the bus line 14, the worse the affect of cross talk on the signals through the conductors. When the parallel ATA interface cable 1 is in a daisy chain configuration, a length of the bus line between the host computer 3 and the second device 7 will be longer than a length of the bus line between the host computer 3 and the first device 5. If a length between the host computer 3 and the first device 5 is long, then the overall length between the host computer 3 and the second device 7 may be too long, thus debasing the quality of the signals conveyed by the bus line 14 and perhaps even corrupting data. Further, the length of the bus line 14 from the host computer 3 and the second device 7 may be greater than allowed by the parallel ATA specification.

What is needed, therefore, is a storage interface cable able to provide a configuration for a host and accompanying devices, which avoids the quality debasement of signals or data corruption because of bus line length.

### SUMMARY

A storage interface cable that conforms to the requirements of the advanced technology attachment (ATA) specification is provided. In a preferred embodiment, the storage interface cable comprises: a bus line conveying signals; a host connector at a middle part of the bus line for being attached to a host; a master connector at an end of the bus line for being attached to a master device; and a slave connector at another end of the bus line for being attached to a slave device.

The storage interface cable is configured so that a length of the bus line between the host connector and the slave connector is not dependent on a length of the bus line between the host connector and the master connector as in a daisy chain configuration. Therefore, the storage interface cable avoids quality debasement of signals or data corruption due to excessive length of the bus line.

Other advantages and novel features will become more apparent from the following detailed description of preferred embodiments when taken in conjunction with the accompanying drawings, in which:

### BRIEF DESCRIPTION OF THE DRAWINGS

FIG. 1 is a block diagram of a parallel ATA storage interface cable of a preferred embodiment of the present invention;

FIG. 2 is a block diagram of the storage interface cable of FIG. 1 interconnecting a host, a master device, and a slave device;

FIG. 3 is a block diagram of a typical parallel ATA storage interface cable; and

FIG. 4 is a block diagram of the typical parallel ATA storage interface cable of FIG. 3 interconnecting a host, a first device, and a second device.

### DETAILED DESCRIPTION OF THE EMBODIMENTS

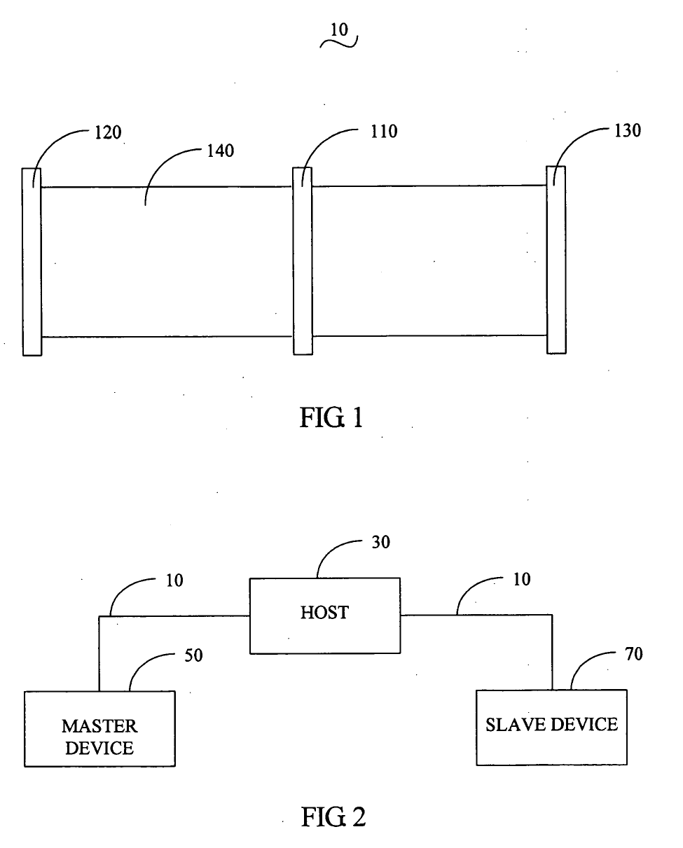

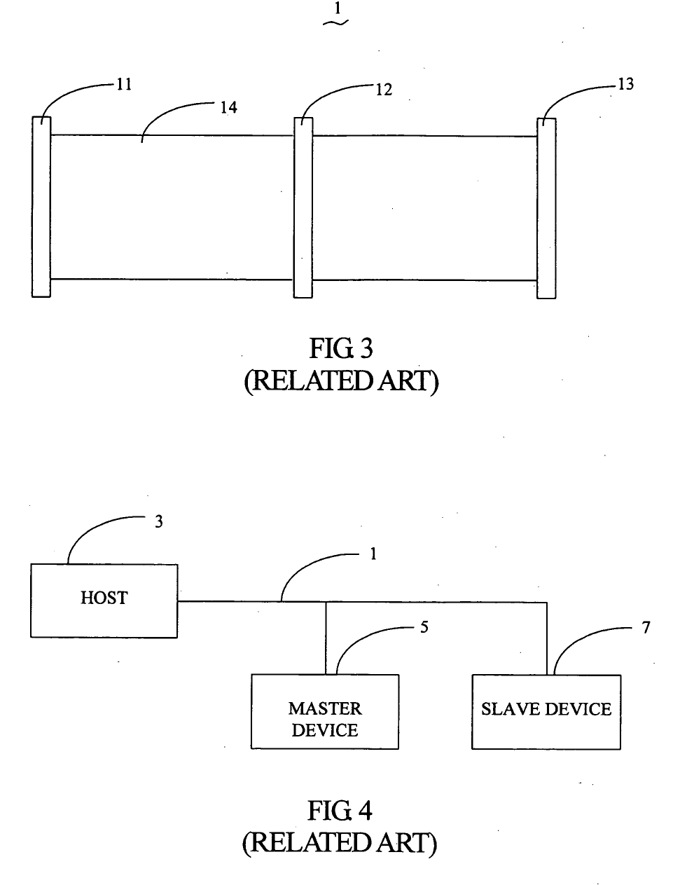

As shown in FIG. 1, in a preferred embodiment of the present invention, a storage interface cable 10, which is used as a connective apparatus and conforms to parallel ATA specifications, such as those of the American National Standards Institute, includes a host connector 110, a master connector 120, a slave connector 130, and a bus line 140.

The host connector 110 is at a middle part of the bus line 140. The master connector 120 is at an end of the bus line 140. The slave connector 130 is at another end of the bus line 140. A length of the bus line 140 between the host 30 and the master device 50 and a length of the bus line 140 between the host 30 and the slave device 70 are both within the limitations of applicable ATA specifications.

As shown in FIG. 2, the host connector 110 is attached to a host 30. The master connector 120 is attached to a master device 50. The slave connector 130 is attached to a slave device 70. The host 30, the master device 50, and the slave device 70 are connected in a Y-shaped configuration. The bus line 140 has 40 conductors or 80 conductors.

In the illustrated embodiment, because the host 30, the master device 50, and the slave device 70 are connected in a Y-shaped chain configuration, thereby avoiding a daisy chain configuration, the length of the bus line 140 between the host 30 and the slave device 70 is not dependent on the length of the bus line 140 between the host 30 and the master device 50. Therefore, the storage interface cable 10 is able to provide a configuration for the host and devices that avoids quality debasement of signals or data corruption due to excessive length of the bus line.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A storage interface cable for advanced technology attachment (ATA) applications, the storage interface cable comprising:
a bus line conveying signals;
a host connector at a middle part of the bus line for being attached to a host;
a master connector at an end of the bus line for being attached to a master device; and
a slave connector at another end of the bus line for being attached to a slave device.

2. The storage interface cable as claimed in claim 1, wherein the bus line has 40 conductors.

3. The storage interface cable as claimed in claim 1, wherein the bus line has 80 conductors.

4. The storage interface cable as claimed in claim 1, wherein a length of the bus line between the host connector and the master connector is within a limitation of an ATA specification applicable to the storage interface cable.

5. The storage interface cable as claimed in claim 1, wherein a length of the bus line between the host connector and the slave connector is within a limitation of an ATA specification applicable to the storage interface cable.

6. A storage interface cable for advanced technology attachment (ATA) applications, the storage interface cable comprising:
a bus line conveying signals;
a host connector for being attached to a host;
a master connector for being attached to a master device; and
a slave connector for being attached to a slave device; wherein
the host connector is connected to the master connector and the slave connector in a Y-shaped configuration by the bus line.

7. The storage interface cable as claimed in claim 6, wherein the bus line has 40 conductors.

8. The storage interface cable as claimed in claim 6, wherein the bus line has 80 conductors.

9. The storage interface cable as claimed in claim 6, wherein a length of the bus line between the host connector and the master connector is within a limitation of an ATA specification applicable to the storage interface cable.

10. The storage interface cable as claimed in claim 6, wherein a length of the bus line between the host connector and the slave connector is within a limitation of an ATA specification applicable to the storage interface cable.

11. A signal-transmissible system comprising:
a signal-transmissible bus line of said system, said bus line defining at least two distal ends thereof;
a device electrically connectable to a selective one of said at least two distal ends for signal transmission thereof; and
a host capable of managing signal transmission between said host and said device through said bus line, said host electrically connectable to a position of said bus line other than any of said at least two distal ends.

12. The system as claimed in claim 11, wherein a host connector is formed from said bus line so as to electrically connect with said host, and a master connector and a slave connector are formed from a respective one of said at least two distal ends so that one of said master and slave connector is capable of being electrically connectable with said device.

13. The system as claimed in claim 11, wherein said signals transmission between said host and said device exclusively uses a part of said bus line between said position of said bus line and said selective one of said at least two distal ends without encountering with another signal transmission between said host and other devices electrically connectable to said bus line.
